(19) United States
(12) Patent Application Publication
(10) Pub. No.: US 2013/0005455 A1
(43) Pub. Date: Jan. 3, 2013

(54) TABLE GAME SYSTEM

(76) Inventors: Kenichi Okujo, Kanagawa (JP); Tomoyuki Hashimoto, Kanagawa (JP)

(21) Appl. No.: 13/340,462

(22) Filed: Dec. 29, 2011

(30) Foreign Application Priority Data
Jun. 30, 2011 (JP) 2011146878

(51) Int. Cl. A63F 13/00

(52) U.S. Cl. 463/30

(57) ABSTRACT

A table game system includes a dealer's game table for performing a table game. A dealer terminal allows input of game result information of the table game. A capturing device can capture game medium used in the table game. A player display part can display an image of the game medium captured by the capturing device. A player terminal allows input of bet information including predicted game result information and betting amount information. The player display part and the player terminal are provided at a location distant from the dealer's game table. A management server stores predetermined dividend rate information corresponding to the game result information. A first communication line connects the dealer terminal, the player terminal, and the management server to each other. A second communication line connects the capturing device to the player display part. The second communication line is different from the first communication line.

### CROSS-REFERENCE TO RELATED APPLICATION

This application is based upon and claims the benefit of priority from Japanese Patent Application No. 2011-146878, filed Jun. 30, 2011, the entire contents of which are incorporated herein by reference.

### BACKGROUND

1. Field of the Invention

The present invention generally relates to a table game system using game media, such as cards and a roulette, and more particularly, to a table game system in which a dealer's game table for playing a table game and a player terminal used by a game player are provided at a distance from each other.

2. Description of the Related Art

Generally, table games, such as card games (e.g., a baccarat game) using playing cards and roulette games using a roulette, are widely known as casino games.

Recently, as for a system for supporting such a table game, for example, a technique has been proposed in which a plurality of player terminals used by game players are installed at locations distant from a table (hereinafter referred to as a “dealer's game table”) where a dealer deals and opens cards, for example, and in which the images (hereinafter referred to as “the card images”) of cards and a shoe captured by a video camera are delivered on a real-time basis (refer to, e.g., Japanese Patent Application Laid-Open Publication No. 2008-245851).

According to such a table game system, it is possible for a lot of game players to participate in a game at the same time that is performed on a dealer's game table.

Here, in the table game system described in Japanese Patent Application Laid-Open Publication No. 2008-245851, a dealer terminal used by the dealer and a management server for managing a whole system are provided in addition to the plurality of player terminals and the video camera, and each of these devices is connected to each other via a single network.

Namely, in such a system, various data is transmitted via a single network. Hence, depending on the transmission condition of the various data, an excessive load is applied to the network, resulting in a disadvantage that a delay occurs in transmission and/or reception of the various data. Especially, when a delay occurs in transmission of image data captured by the video camera, the game players cannot see the card images on a real-time basis. Thus, there is a problem in that it is difficult to find a fraud such as replacement of cards by a dealer.

Additionally, in the case where a network failure occurs due to a mechanical failure of a video distributer that connects the video camera to the network, it becomes impossible to deliver the image data to the player terminals, and to transmit and receive the various data to and from among the other devices. As a result, there is a problem in that the progress of the table game is stopped.

### SUMMARY

An object of the present invention is to provide a table game system that can smoothly transmit and receive various data by reducing a load applied to a network, and can minimize the effect of a network failure even when the network failure occurs.

According to a first aspect of the present invention, a table game system includes: a dealer's game table for performing a table game; a dealer terminal configured to allow input of game result information of the table game performed on the dealer's game table; a capturing device configured to be able to capture game medium used in the table game; a player display part configured to be able to display an image of the game medium captured by the capturing device, the player display part being provided at a location distant from the dealer's game table; a player terminal configured to allow input of bet information including predicted game result information and betting amount information, the player terminal being provided at a location distant from the dealer's game table; a management server configured to store predetermined dividend rate information corresponding to the game result information; a first communication line configured to connect the dealer terminal, the player terminal, and the management server to each other; and a second communication line configured to connect the capturing device to the player display part, the second communication line being different from the first communication line.

Here, the “table game” recited in the present invention refers to a game played on a table, such as a card game (e.g., a baccarat game) using cards such as playing cards, a roulette game in which a ball is thrown in a rotating wheel, and a dice game using a dice, that is, a game in which the game is started and the game result is obtained by the initiative of a dealer.

As mentioned above, with the above-described configuration, the various data transmitted among the dealer terminal, the player terminal, and the management server, and image data transmitted between the capturing device and the player display part are transmitted separately via the first communication line and the second communication line, respectively. Hence, it is possible to reduce loads on these communication lines. As a result, it is possible to smoothly transmit the image data as well as the various data. Accordingly, with the above-described configuration, since the various data can be transmitted without a delay, it is possible to smoothly proceed with the table game, and to enable a game player to view a card image displayed on the player display part on a real-time basis. Hence, it is possible to effectively prevent a fraud by a dealer.

With the above-described configuration, only the image data not always necessary for proceeding with the game is transmitted via the second communication line. Accordingly, even when a trouble occurs in the second communication line, such as breaking or disconnection, the first communication line is not affected by the trouble. Therefore, it is possible to effectively prevent a disadvantage that the progress of the table game is stopped due to such a trouble.

On this occasion, it is preferable that the dealer terminal transmits the game result information to the player terminal, the management server transmits the dividend rate information to the player terminal, and the player terminal stores the bet information that is input, and the game result information and the dividend rate information that are received, determines whether or not the predicted game result information matches the game result information, and, when the player terminal determines that the predicted game result information matches the game result information, calculates dividend information based on the betting amount information and the dividend rate information. With such a configuration, the game result information and the corresponding dividend rate information are stored in the management server instead of each player terminal. Hence, it is possible to eliminate a cumbersome process to store these kinds of information in each player terminal every time these kinds of information is changed. Additionally, since the dividend rate information is not stored in the player terminal, it is possible to positively prevent a fraud, such as changing the dividend rate information in order to obtain a large benefit.

In addition, instead of the above-described configuration, it is also possible to apply a configuration in which the dealer terminal transmits the game result information to the management server, the player terminal transmits the bet information to the management server, and the management server stores the game result information and the bet information that are received, determines whether or not the predicted game result information matches the game result information, and when the management server determines that the predicted game result information matches the game result information, calculates dividend information based on the betting amount information and the dividend rate information, and the player terminal receives the dividend information. With such a configuration, the calculation of the dividend information is performed in the management server instead of the player terminal. Hence, it is possible to positively reduce the control load on the player terminal.

As described above, according to the table game system of the present invention, it is possible to reduce the load on a communication line (network). Hence, it is possible to smoothly proceed with a table game, and to effectively prevent a fraud by a dealer.

### BRIEF DESCRIPTION OF THE DRAWINGS

FIG. 1 is an exemplary block diagram illustrating an exemplary configuration of a table game system according to a first embodiment;

FIG. 2 is an exemplary diagram for explaining an exemplary installment of the table game system according to the first embodiment;

FIG. 3 is an exemplary block diagram illustrating an exemplary structure of a dealer terminal according to the first embodiment;

FIG. 4 is an exemplary perspective view illustrating a player terminal according to the first embodiment;

FIG. 5 is an exemplary block diagram illustrating an exemplary structure of the player terminal according to the first embodiment;

FIG. 6 is an exemplary diagram illustrating an example of a display screen displayed on a display part of the player terminal according to the first embodiment;

FIG. 7 is an exemplary enlarged view of a part of FIG. 6;

FIG. 8 is an exemplary table of a BET information storage area provided in the player terminal according to the first embodiment;

FIG. 9 is an exemplary block diagram illustrating an exemplary structure of a management server according to the first embodiment;

FIG. 10 is an exemplary diagram illustrating an example of a display screen displayed on a display part of the management server according to the first embodiment;

FIG. 11 is an exemplary flowchart of an exemplary control process in a dealer terminal according to the first embodiment;

FIG. 12 is an exemplary flowchart of an exemplary control process in the player terminal according to the first embodiment;

FIG. 13 is an exemplary flowchart of an exemplary BET information storing process in the player terminal according to the first embodiment;

FIG. 14 is an exemplary flowchart of an exemplary dividend information calculation process in the player terminal according to the first embodiment;

FIG. 15 is an exemplary flowchart of an exemplary control process in the management server according to the first embodiment;

FIG. 16 is an exemplary flowchart of an exemplary control process in a management server according to a second embodiment; and

FIG. 17 is an exemplary table of a dividend information storage area provided in the management server according to the second embodiment.

### DETAILED DESCRIPTION

### First Embodiment

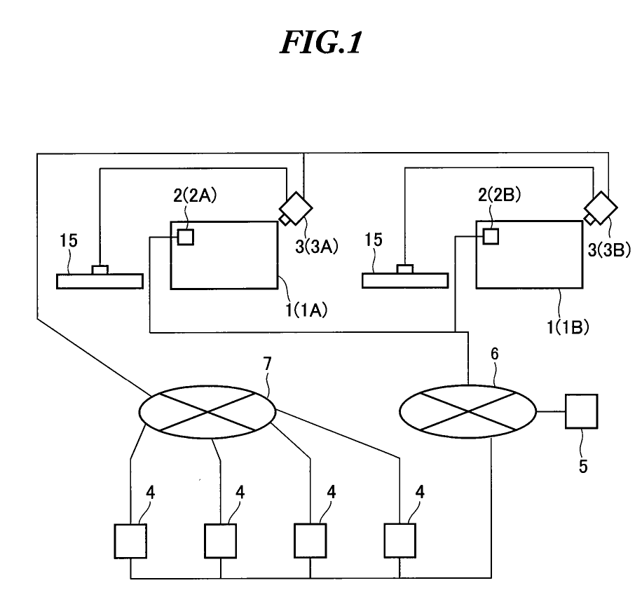

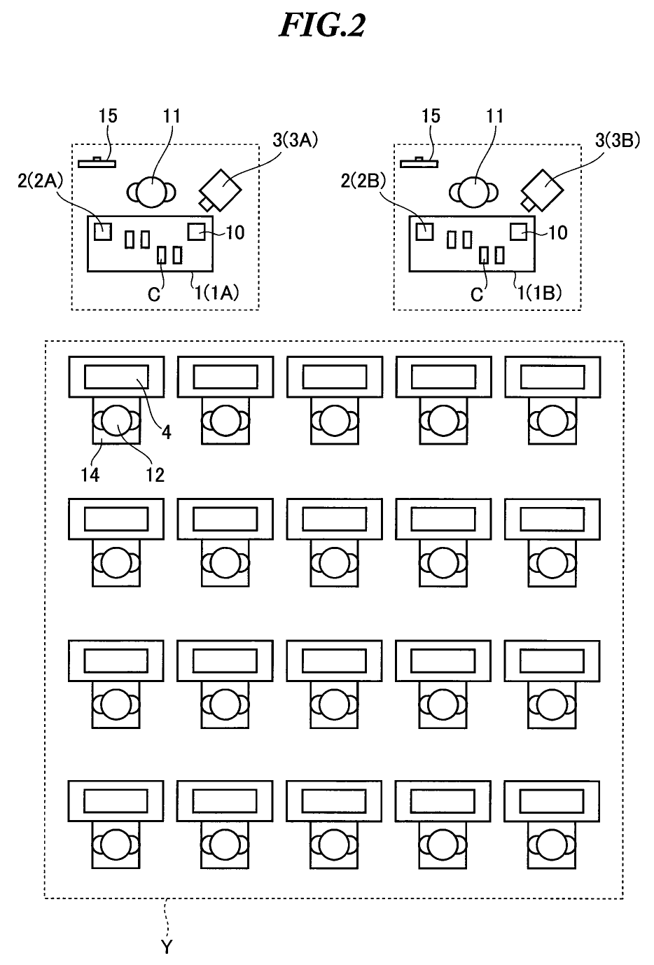

As shown in FIG. 1 and FIG. 2, a table game system according to a first embodiment includes a plurality of (in this embodiment, two) dealer's game tables 1 for performing a baccarat game as a table game, dealer terminals 2 that allow the input of game result information and the like of the table games performed on the respective dealer's game tables 1, capturing cameras 3 that can capture cards C, shoes 10 and the like actually used in the respective the dealer's game tables 1, a plurality of player terminals 4 that allow the input of BET information and the like with respect to the table games performed on the respective the dealer's game tables 1, a management server 5 that stores the game result information and dividend rate information corresponding to the game result information, a first network 6, and a second network 7. It should be noted that, in the following description, for the sake of convenience, the table game performed on the dealer's game table 1A is referred to as the table game A, and the table game performed on a the dealer's game table 1B is referred to as the table game B.

Additionally, in this embodiment, a baccarat game is performed on each of the dealer's game table 1A and the dealer's game table 1B. However, this is not the limitation, and it is possible to perform other table games (for example, various table games in which the game is started and the game result is obtained by the initiative of a dealer 11, such as a roulette game in which a ball is thrown in a rotating wheel, and a dice game using a dice).

Further, in this embodiment, the two the dealer's game tables 1 for performing the table games are provided. However, the number of the dealer's game tables may be three or more.

As shown in FIG. 2, only those required for the dealer 11, such as the dealer terminal 2, the shoe 10, a place for placing Banker cards, a place for placing Player cards and the like, are provided on each of the dealer's game tables 1.

That is, a place and the like for a game player 12 to place a bet, which are provided to a usual baccarat table, are not provided to each of the dealer's game tables 1 according to this embodiment. Thus, a table smaller than a conventional dealer's game table is used as the dealer's game table 1.

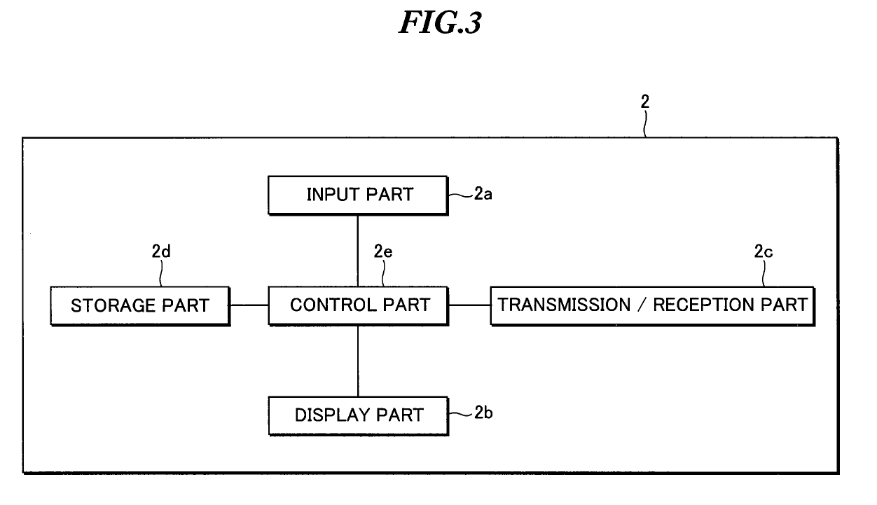

As shown in FIG. 2 and FIG. 3, the dealer terminal 2 can be operated only by the dealer 11, and includes an input part 2a that allows the input of various data, a display part 2b such as a display that can display the various data, a transmission/reception part 2c, such as a modem or a terminal adapter, which is connected to the first network 6 and transmits and receives the various data, a storage part 2d that stores the various data, and a control part 2e that controls the input part 2a, the display part 2b, the transmission/reception part 2c, and the storage part 2d.

The input part 2a is formed by, for example, a keyboard, a numerical keypad, a mouse or the like. The dealer 11 can input the game result information and information indicating the start of betting and the end of betting, by operating the input part 2a in accordance with the progress of the table game. As described later, in this embodiment, the game result information and the like that are input from the input part 2a of the dealer terminal 2 are transmitted to the player terminals 4 via the first network 6.

The storage part 2d is formed by a storage device, such as a ROM and/or a RAM, and includes a BET start flag storage area for the table game A, a BET end announcement flag storage area for the table game A, a BET end flag storage area for the table game A, a BET start flag storage area for the table game B, a BET end announcement flag storage area for the table game B, a BET end flag storage area for the table game B and the like. It should be noted that various flags to be stored in these respective storage areas are set to these storage areas when there is input of the above-described information indicating the start of betting and the end of betting.

Next, referring to FIG. 1 and FIG. 2, a description is given of the capturing camera 3.

The capturing cameras 3 are attached to the respective dealer's game tables 1 via supporting members or the like. The capturing camera 3 is, for example, a video camera for recognizing the cards C, the shoe 10 and the like in two-dimensional shapes by capturing images by using a CCD.

The image data captured by the capturing camera 3 is transmitted to the player terminal 4 via the second network 7. The player terminal 4 receives the image data, and displays the image data on display parts 4e, which will be described later. In addition, the image data is displayed on a large display 15, such as a plasma display or a liquid crystal display, which is provided for each of the dealer's game tables 1.

Further, in this embodiment, one capturing camera 3 for capturing the cards C and the shoe 10 is provided for each of the dealer's game tables 1. However, it is possible to provide two capturing cameras for each of the dealer's game tables 1: one capturing camera for capturing the cards C; and the other capturing camera for capturing the shoe 10.

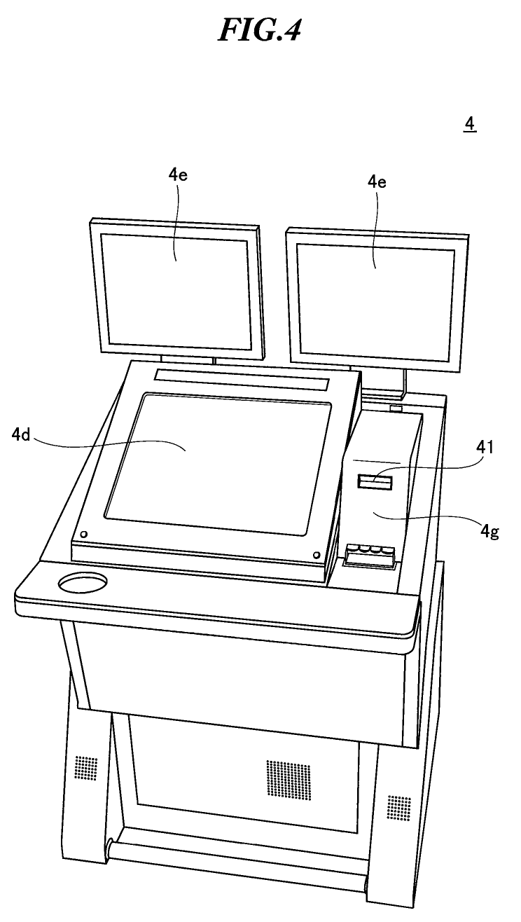

Next, referring to FIG. 1, FIG. 2, and FIG. 4 through FIG. 7, a description is given of the player terminal 4.

As shown in FIG. 1 and FIG. 2, the player terminals 4 are used only by the game players 12, and are arranged in a game player space Y provided at a predetermined distance from each of the dealer's game tables 1. 20 player terminals 4 in total are arranged in order, such that five player terminals 4 are arranged in a horizontal direction, and four player terminals 4 are arranged in a vertical direction. Additionally, the player terminals 4 are provided with respective chairs 14 on which the game players 12 can sit.

As described above, in this embodiment, all of the game players 12, who are users, do not sit behind one table, and the dealer's game tables 1 are separated from the player terminals 4. Accordingly, it is possible to provide a wide personal space, and the game players 12 can participate in the game in a relaxed manner, or with concentration without being disturbed by other players' play.

Additionally, it is not always necessary to provide the dealer's game tables 1 and the player terminals 4 in the same location. For example, the game player space Y may be provided in a café, a restaurant, a room of a hotel, a room of his/her house or the like, and may be connected to a network such as the Internet. In this case, an actual table game is performed on the dealer's game table 1, and the user can place a bet in the café, the restaurant, the room of the hotel, the room of his/her house or the like.

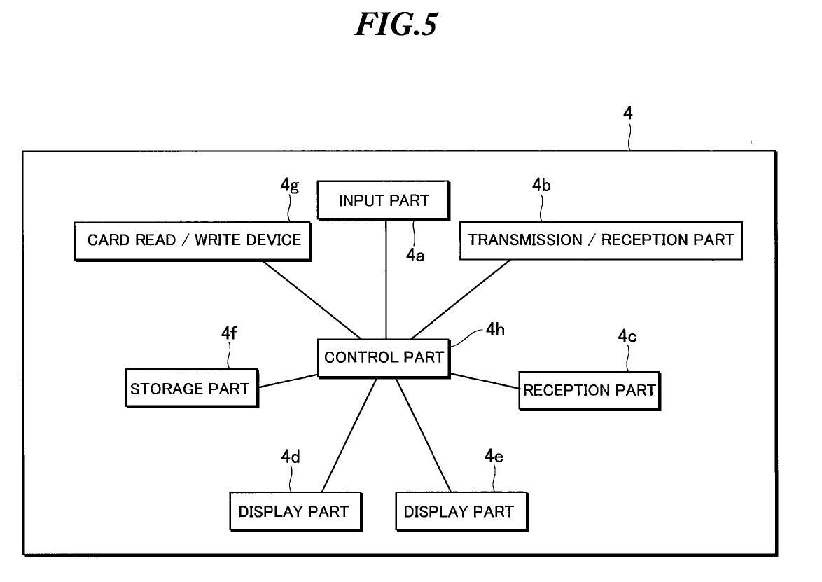

As shown in FIG. 2, FIG. 4 and FIG. 5, the player terminal 4 includes an input part 4a that allows the input of information (hereinafter referred to as “the BET information”) such as a predicted game result with respect to each table game and a betting amount to the predicted game result, a transmission/reception part 4b to establish connection with the first network 6, a reception part 4c to establish connection with the second network 7, a display part 4d that can display various data such as the BET information, a plurality of (in this embodiment, two) display parts 4e that can each display the images of the cards C and the shoe 10 captured by each of the capturing cameras 3A and 3B, a storage part 4f that stores the various data, a card read/write device 4g, and a control part 4h that controls the input part 4a, the transmission/reception part 4b, the reception part 4c, the display part 4d, the plurality of display parts 4e, the storage part 4f, and the card read/write device 4g.

The input part 4a is a touch panel input part provided on a top surface of the display part 4d.

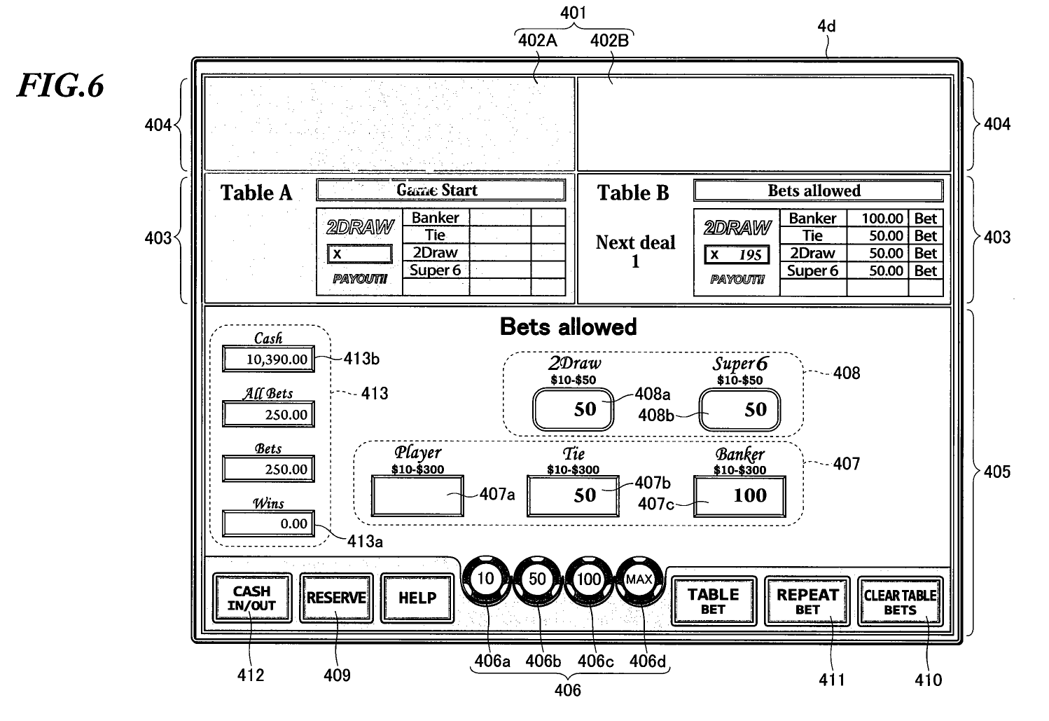

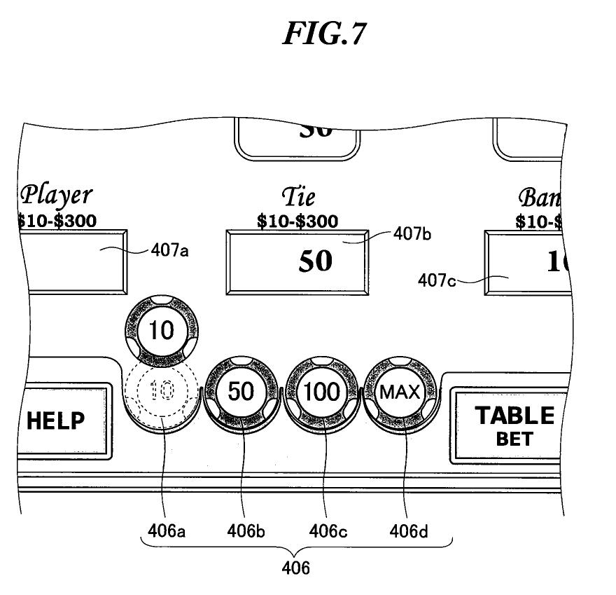

As shown in FIG. 6 and FIG. 7, for example, it is possible to select one betting amount information image from among a plurality of betting amount information images 406a, 406b, 406c and 406d that are displayed on a betting amount information display portion 406 of the display part 4d, by touching a desired betting amount information image via a display surface of the input part 4a. In addition, the input part 4a is not limited to the touch panel input part, and may be a switch, a button, or the like.

As shown in FIG. 1 and FIG. 5, the transmission/reception part 4b is formed by a modem, a terminal adapter or the like for transmitting and receiving various data. The transmission/reception part 4b receives the game result information transmitted from the dealer terminal 2, and receives history information (baccarat result table information) and the dividend rate information stored in the management server 5.

The reception part 4c is formed by a modem, a terminal adapter or the like, in a manner similar to the transmission/reception part 4b. The reception part 4c receives the image data of the cards C, the shoe 10 and the like captured by each of the capturing cameras 3A and 3B. When the image data is received by the reception part 4c, the image of the cards C and/or the shoe 10 is displayed on the display parts 4e.

As shown in FIG. 6, the display part 4d includes a table game selection image display area 401 and a BET information input image display area 405.

The table game selection image display area 401 includes a table game A selection image display portion 402A for selecting the table game A performed on the dealer's game table 1A, and a table game B selection image display portion 402B for selecting the table game B performed on the dealer's game table 1B.

In this embodiment, by touching either one of the display screens, i.e., the table game A selection image display portion 402A or the table game B selection image display portion 402B, the display of the BET information input image display area 405 is switched between a BET information input screen that allows the input of the BET information with respect to the table game A, and a BET information input screen that allows the input of the BET information with respect to the table game B.

Taking FIG. 6 as an example, when the game player 12 selects the table game B by touching the display surface of the table game B selection image display portion 402B, the display of the BET information input image display area 405 is switched to the BET information input screen corresponding to the table game B. Additionally, the table game B selection image display portion 402B is displayed brightly, so as to allow the game player to clearly view the contents displayed in the table game B selection image display portion 402B. On the other hand, the table game A selection image display portion 402A is displayed somewhat darkly, so that the contents displayed in the table game A selection image display portion 402A become less visible, though the contents can be viewed by the game player 12.

That is, according to this embodiment, it is possible to immediately recognize the currently selected table game. Hence, it is possible to prevent the game player 12 from erroneously placing a bet on a different table game.

Moreover, according to this embodiment, it is possible to check not only the currently selected table game but also the other table game by viewing the contents (the contents displayed in a BET information display portion 403 and a history information display portion 404, which will be described later) of the table game A selection image display portion 402A and the table game B selection image display portion 402B. Accordingly, it is possible for the game player 12 to view the information of both the table games A and B without a specific operation.

Each of the table game A selection image display portion 402A and the table game B selection image display portion 402B includes the BET information display portion 403 and the history information display portion 404. The BET information display portion 403 displays how much betting amount information is bet on which predicted game result information with respect to the table game. The history information display portion 404 can display the history information (the baccarat result table information including a series of recent game result data) and the like transmitted from the management server 5. Further, in this embodiment, the BET information display portion 403 and the history information display portion 404 are displayed in each of the table game A selection image display portion 402A and the table game B selection image display portion 402B. However, it is possible to display the other contents in each of the table game A selection image display portion 402A and the table game B selection image display portion 402B, as long as the contents relate to the table game.

The BET information display portion 403 of each of the table game A selection image display portion 402A and the table game B selection image display portion 402B can display the status of a current table game, specifically, information such as “You can place a bet (Bets allowed)”, “Betting is closed (Bets are closed)” and the like.

The BET information input image display area 405 includes the betting amount information display portion 406 that displays a plurality of kinds of betting amount information, a mandatory predicted game result information display portion 407 that displays a plurality of kinds of mandatory predicted game result information, an optional predicted game result information display portion 408 that displays a plurality of kinds of optional predicted game result information, a reserve button 409 that is operated for reserving the terminal when leaving his/her seat for, e.g., using bathroom, a clear table bets button 410 that is operated for clearing the amount of money of all bets, a repeat bet button 411 that is operated for betting the same betting amount information as the table game previously performed, a cash in/out button 412 for adjusting money information when ending the table game, and a money information display portion 413 that can display the money information and the like of the game player 12.

The betting amount information display portion 406 displays the betting amount information images 406a, 406b, 406c and 406d imitating chips on which “10”, “50”, “100” and “MAX” are drawn, for example.

The mandatory predicted game result information display portion 407 displays the images indicating mandatory game result information adopted in a usual baccarat game, i.e., three kinds of mandatory predicted game result information images 407a, 407b and 407c, such as “Player”, “Tie” and “Banker”, respectively.

Differing from the above-described mandatory predicted game result information, the optional predicted game result information display portion 408 displays, for example, game result information images that are arbitrarily determined by a house.

In this embodiment, “2 Draw” (the case where the game result is Tie with the card value of “2”) and “Super 6” (the case where “Banker” wins with the card value of “6”) are set as the game result information that are arbitrarily determined by the house. Thus, these two kinds of optional predicted game result information images 408a and 408b are displayed in the optional predicted game result information display portion 408.

It should be noted that the optional predicted game result information is not limited to the above-described two kinds of information, and three or more kinds of information may be displayed.

Here, a description is given of an exemplary procedure for placing a bet on the table game A or the table game B by the game player 12.

First, the game player 12 selects the table game to which he or she desires to input the BET information, by touching either one of the table game A selection image display portion 402A and the table game B selection image display portion 402B via the display surface of these display portions. As a result, the BET information input screen that allows the input of the

BET information of the table game A or the BET information input screen that allows the input of the BET information of the table game B is displayed in the BET information input image display area 405 in a switching manner.

Next, when the game player 12 touches, via the display surface, one of the betting amount information images 406a through 406d displayed in the betting amount information display portion 406 of the BET information input image display area 405, the numeric value indicated by the touched betting amount information image is set as the betting amount information for a single operation.

As shown in FIG. 6 and FIG. 7, in this embodiment, for example, when the game player 12 touches the betting amount information image 406a on which “10” is drawn, the touched betting amount information image 406a is moved upward.

In this state, when the game player 12 touches, via the display surface, one of the mandatory predicted game result information images 407a, 407b and 407c, such as “Player”, “Tie” and “Banker”, displayed in the mandatory predicted game result information display portion 407 and the optional predicted game result information images 408a and 408b, such as “2 Draw” and “Super 6”, displayed in the optional predicted game result information display portion 408, the set betting amount as described above is bet to the predicted game result information corresponding to the selected predicted game result information.

Taking FIG. 7 as an example, in the state where the betting amount information image 406a, on which is “10” is drawn, is moved upward, when the mandatory predicted game result information image 407b, on which “Tie” is drawn, is touched via the display surface of the input part 4a, the betting amount information “10” is bet to the predicted game result information “Tie”. Further, by consecutively touching, via the display surface of the input part 4a, the mandatory predicted game result information image 407b on which “Tie” is drawn, in accordance with the number of times of touching, the betting amount information is incremented by “10” and bet to the predicted game result information “Tie”, such that “20”, “30”, “40”, “50”, . . . .

On this occasion, the mandatory predicted game result information image 407b displays the total amount of bets (total betting amount information) which is currently bet to the mandatory predicted game result information. Additionally, the total amount of bets is also displayed in the money information display portion 413 and the BET information display portion 403 of the table game A selection image display portion 402A or the table game B selection image display portion 402B.

Additionally, it is possible to change the betting amount information for a single operation by touching, via the display surface of the input part 4a, one of the betting amount information images 406a through 406d that is not moved upward.

In this manner, according this embodiment, when one of the betting amount information images 406a through 406d is touched via the display surface of the input part 4a, the selected image is moved upward and displayed. That is, the game player 12 can clearly recognize the betting amount information currently selected (the betting amount for a single operation that is currently set). Hence, it is possible to effectively prevent a disadvantage that erroneous betting amount information is bet to the predicted game result information.

Additionally, in this embodiment, when one of the betting amount information images 406a through 406d is selected, the selected betting amount information image is moved upward and displayed. However, the selected betting amount information image may be moved in other directions. Further, in addition to such a movement of the betting amount information image, it is possible to, for example, brightly display the selected betting amount information image, or change the color of the selected betting amount information image.

Furthermore, in addition to the configuration in which, when one of the betting amount information images 406a through 406d is selected, the selected image is moved and displayed, it is possible to apply a configuration in which, when one of the predicted game result information images (the mandatory predicted game result information images 407a through 407c, and the optional predicted game result information images 408a and 408b) is selected, the selected image is moved and displayed.

As a result, the game player 12 can clearly recognize the selected predicted game result information. Accordingly, it is possible to effectively prevent a disadvantage that the betting amount information is bet to erroneous predicted game result information.

As shown in FIG. 4, the plurality of display parts 4e are each provided behind the display part 4d. The display part 4e on the left side displays the images of the cards C, the shoe 10 and the like on a real-time basis that are captured by the capturing camera 3A provided for the dealer's game table 1A. Similarly, the display part 4e on the right side displays the images of the cards C, the shoe 10 and the like on a real-time basis that are captured by the capturing camera 3B provided for the dealer's game table 1B.

As shown in FIG. 5, the storage part 4f is formed by, for example, a storage device such as a ROM and/or a RAM, and includes a BET information storage area, a money information storage area (not shown), a BET information input permission flag 1 storage area, a BET information input permission flag 2 storage area and the like.

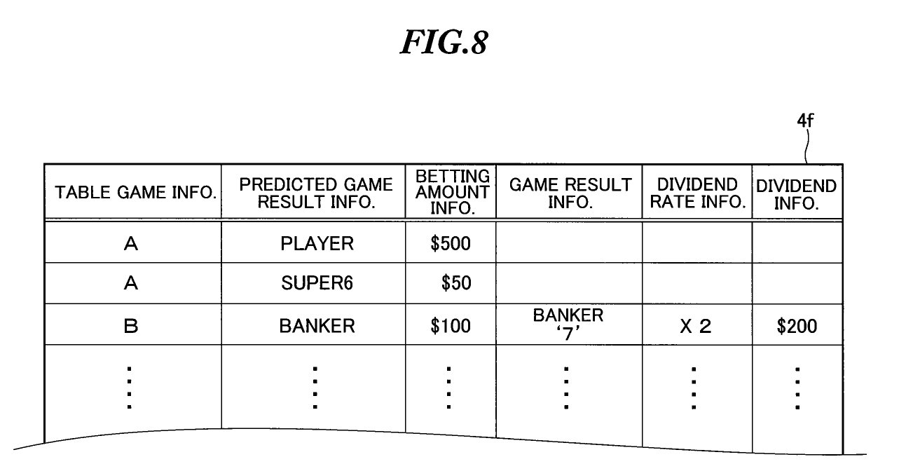

As shown in FIG. 8, the BET information storage area includes areas that allow writing of “table game information”, “predicted game result information”, “betting amount information”, “game result information”, “dividend rate information”, and “divided information”.

The “table game information” is an area for temporarily storing information (e.g., table game “A” or table game “B”) for identifying the table game to which the BET information (the predicated game result information and the betting amount information) is input.

The “predicted game result information” is an area for temporarily storing the predicted game result information (e.g., “Player”, “Banker”, “Tie” or the like), to which the game player 12 places a bet, in association with the “table game information”.

The “betting amount information” is an area for temporarily storing the betting amount information (e.g., “$10” or the like), which is bet by the game player 12, in association with the “predicted game result information”.

The “game result information” is an area for temporarily storing the game result information (e.g., “Player”, “Banker”, “Tie” or the like) transmitted from the dealer terminal 2.

The “dividend rate information” is an area for temporarily storing the dividend rate information (e.g., the dividend rate information “×2” when the game result is “Player”) received from the management server 5.

The “divided information” is an area for temporarily storing the dividend information calculated based on the “betting amount information” and the “dividend rate information”. Additionally, in this embodiment, such calculation of the dividend information is performed by each of the player terminals 4.

In addition, as described later, each kind of information stored in the BET information storage area is temporarily stored until the calculation of the dividend information is performed.

The money information storage area is an area that temporarily stores the money information recorded on a recording card (not shown) inserted into the card read/write device 4g, and stores the money information updated (increased/decreased) in accordance with the win/loss of the table game.

As shown in FIG. 4, the card read/write device 4g is a device for reading and deleting the money information recorded on the recording card, and writing the money information on the recording card. Any form of card, such as a magnetic card or an IC card, can be applied to the recording card as long as the card allows writing and deleting of card information (the money information).

A card insertion opening 41 for inserting the recording card is provided in a front surface of the card read/write device 4g. Further, the card read/write device 4g can write the money information on the recording card, in addition to read and delete the money information recorded on the recording card by using a read/write head (not shown).

In this embodiment, when the recording card, on which the money information is recorded, is inserted into the card insertion opening 41, the read/write head reads the money information, and the money information is stored in the money information storage area of the storage part 4f. In this manner, the game player 12 can place a bet to each table game.

Further, in this embodiment, when the money information recorded on the recording card is stored in the money information storage area, the money information is deleted by the read/write head, and the recording card is ejected from the card insertion opening 41. In addition, the adjustment (cash in/out) of the money information is performed by inserting the recording card, from which the money information is deleted as described above, into the card insertion opening 41, and touching the cash in/out button 412 (see FIG. 6) displayed on the display part 4d via the display surface of the input part 4a. In this manner, the money information stored in the money information storage area at the present moment is written to the recording card by the read/write head, and then, the recording card on which the money information is recorded is ejected from the card insertion opening 41.

Additionally, in this embodiment, the table game can be performed by inserting the recording card into the card insertion opening 41. However, this is not the limitation, and it is possible to adopt a configuration in which the table game can be performed by inserting cash or the like instead of the recording card.

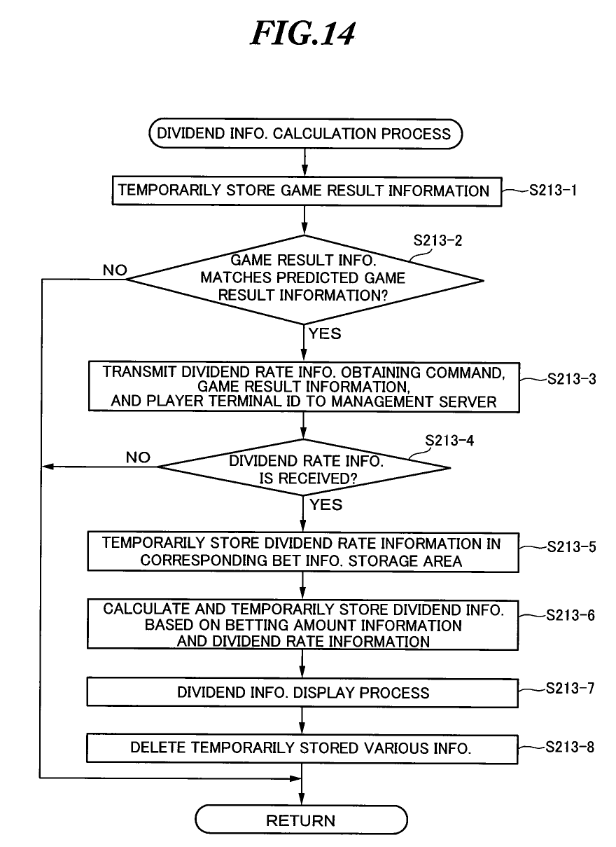

As shown in FIG. 5, the control part 4h according to this embodiment is formed by, for example, a CPU (central processing unit). In addition to the display control of the image displayed on the display part 4d as described above, the control part 4h calculates the dividend information based on the BET information stored in each of the BET information storage area for the table game A and the BET information storage area for the table game B, and the game result information and the like transmitted from each of the dealer terminal 2A and the dealer terminal 2B. The calculation of the dividend information is described later with reference to, for example, FIG. 14.

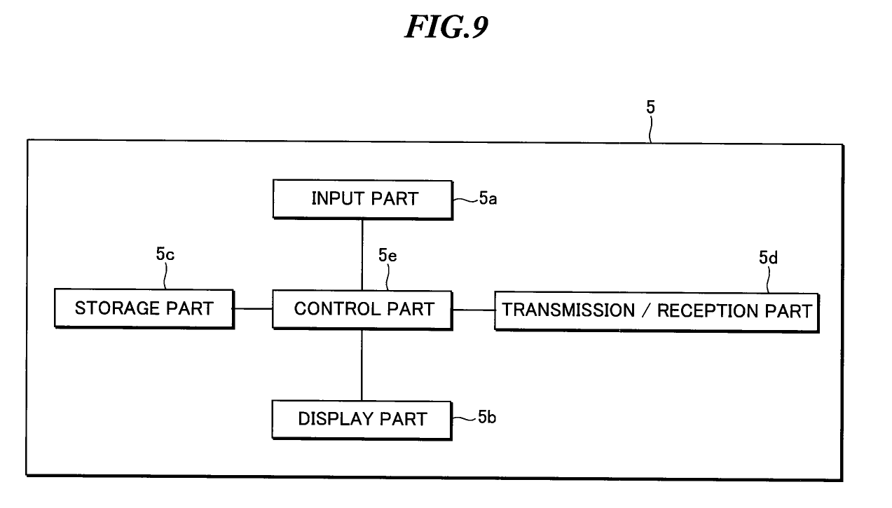

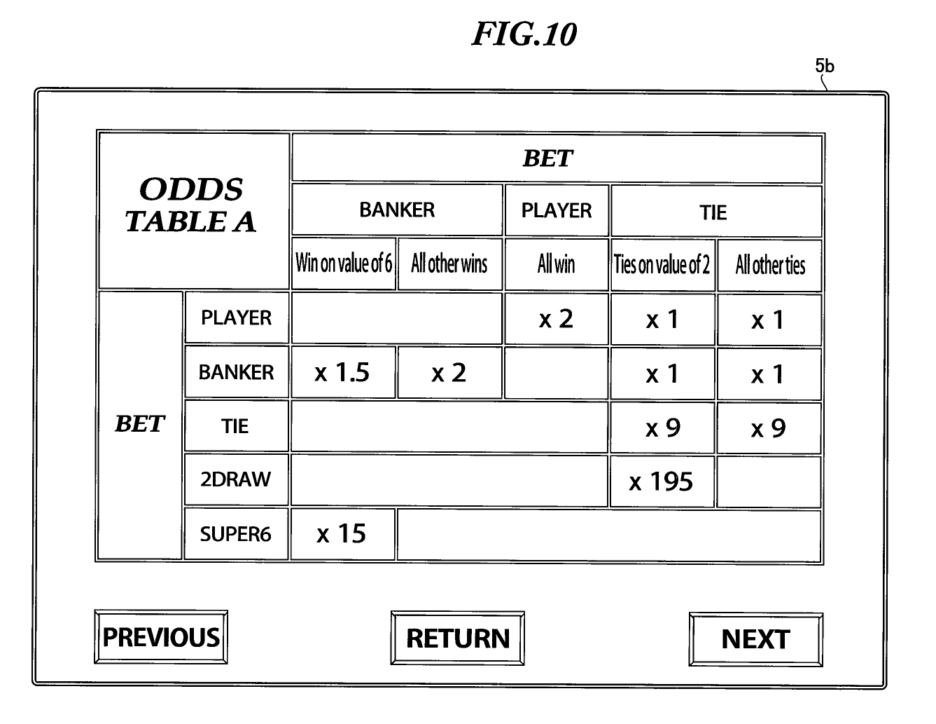

Next, referring to FIG. 1, FIG. 2, FIG. 9 and FIG. 10, a description is given of the management server 5.

The management server 5 includes an input part 5a, such as a keyboard, a numerical keypad, or a mouse, which allows the input of data of the game result information, the dividend rate information corresponding to the game result information and the like, a display part 5b that can display various data, a storage part 5c that stores the various data, a transmission/reception part 5d that establishes connection with the first network 6, and a control part 5e that controls the input part 5a, the display part 5b, the storage part 5c, and the transmission/reception part 5d.

The storage part 5c is formed by, for example, a storage device such as a ROM and/or a RAM, and includes a dividend rate information storage area that stores the dividend rate information corresponding to the game result information, and a history information storage area (not shown) that aggregates and stores the game result information and the like.

In this embodiment, as for the game result information of the table game, it is possible to set the optional predicted game result information (e.g., “2 Draw”, “Super 6” or the like), in addition to “Player”, “Banker” and “Tie”, which are the mandatory predicted game result information. Further, corresponding to such a configuration, it is also possible to arbitrarily set the dividend rate information corresponding to each kind of game result information.

As shown in FIG. 10, it is possible to perform such setting of the game result information and the dividend rate information by an employee or the like by operating the input part 5a while viewing a dividend rate setting screen displayed on the display part 5b. The dividend rate information set in this manner is stored in the dividend rate information storage area in association with the game result information.

For example, in principle, the dividend rate information is set to “×2” for the mandatory predicted game result information “Banker”. However, it is possible to set the dividend rate information to “×1.5” when “Banker” wins with the value of “6” (Win on value of 6).

Additionally, in the case where the house adopts “2 Draw” as an optional game result, it is also possible to set “2 Draw” for the optional predicted game result information, and to set “×195” for the corresponding dividend rate information.

As described above, according to this embodiment, it is possible to additionally set the optional predicted game result information arbitrarily determined by the house as well as the mandatory predicted game result information that is necessary for the table game. Moreover, it is possible to arbitrarily set the dividend rate information corresponding to these kinds of game result information. Hence, it is possible to arbitrarily increase the game result information of the table game, and therefore it is possible to increase the enjoyment of the table game.

The history information storage area updates and stores the history and the like of the BET information and the game result information, based on the betting amount information and the game result information (predicted game result information) transmitted from the player terminals 4. By storing such information related to the history, it is possible to create a baccarat result table (a table showing the history of a series of recent game result data), and to keep track of the sale of the house and the like.

The transmission/reception part 5d is formed by a modem, a terminal adapter or the like. The transmission/reception part 5d receives the predicted game result information (game result information) transmitted from the player terminals 4, and transmits the dividend rate information corresponding to the predicted game result information.

Next, referring to FIG. 1, a description is given of the first network 6 and the second network 7.

The first network 6 and the second network 7 are formed by communication lines, such as a LAN (Local Area Network) and the Internet.

The first network 6 connects the transmission/reception parts 2c of the dealer terminals 2, the transmission/reception parts 4b of the player terminals 4, and the transmission/reception part 5d of the management server 5 to each other. The game result information transmitted from the dealer terminals 2, the dividend rate information transmitted from the management server 5 and the like are transmitted to the player terminals 4 via the first network 6. Additionally, the game result information and the like transmitted from the player terminals 4 are also transmitted to the management server 5 via the first network 6.

The second network 7 connects each of the capturing cameras 3 to the reception parts 4c of the player terminals 4. Image signals (video signals) of the cards C and the shoes 10 captured by the capturing cameras 3 are input to the display parts 4e of the player terminals 4 via the second network 7.

Namely, in this embodiment, the various data transmitted among the dealer terminals 2, the player terminals 4 and the management server 5, and the image data transmitted between the capturing cameras 3 and the player terminals 4 are transmitted separately via the first network 6 and the second network 7, respectively. Hence, it is possible to reduce the loads on these networks.

Additionally, in this embodiment, the display parts 4e provided to the player terminals 4 are connected to the second network 7. However, in addition to the display parts 4e, it is possible to connect other display devices to the second network 7, such as the large display 15 provided in a location distant from the player terminals 4. Further, it is also possible to connect only the above-described display devices other than the display parts 4e of the player terminals 4.

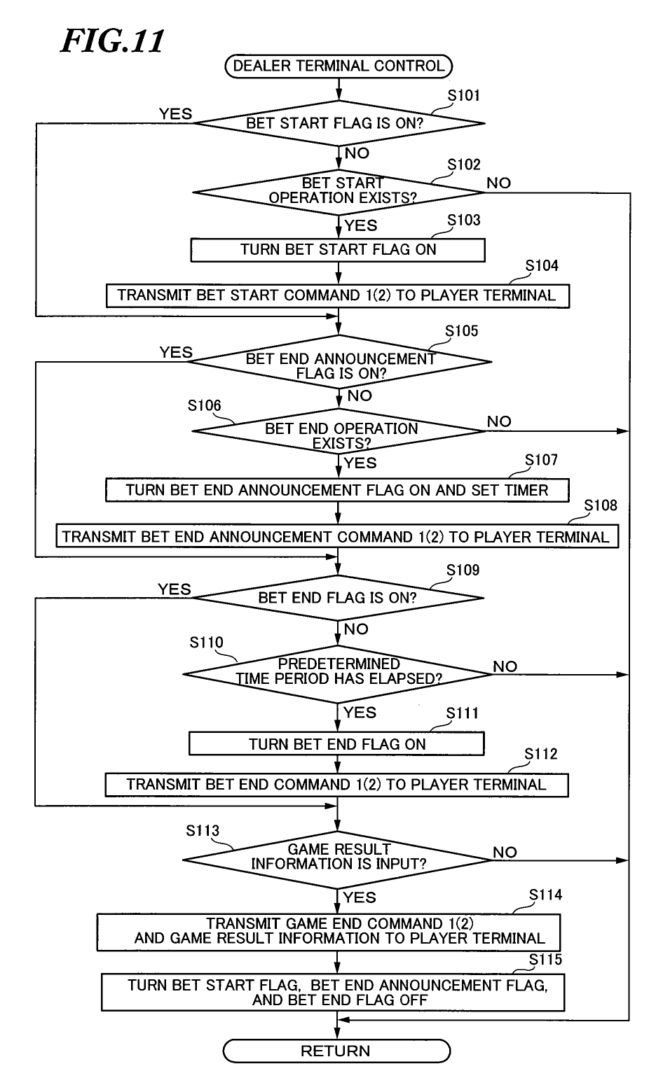

Next, referring to FIG. 11 through FIG. 16, a description is given of an exemplary operation of the table game system according to this embodiment. The operation of the table game system for the table game A is similar to the operation of the table game system for the table game B. Thus, in the following description, only the game system for the table game A is described, and a description of the table game system for the table game B is omitted unless necessary.

### (Dealer Terminal Control)

Referring to FIG. 11, a description is given of an exemplary control operation in the dealer terminal 2A.

### (Step S101)

In step S101, the control part 2e of the dealer terminal 2A determines whether or not a BET start flag is set (turned ON) to the BET start flag storage area for the table game A of the storage part 2d. The BET start flag is set (turned ON) in the process of step S103.

When the BET start flag is set to the BET start flag storage area for the table game A, the control part 2e proceeds to the process of step S105. When the BET start flag is not set to the BET start flag storage area for the table game A, the control part 2e proceeds to the process of step S102.

### (Step S102)

In step S102, the control part 2e determines whether or not the dealer 11 inputs information indicating the start of betting by operating the input part 2a of the dealer terminal input part 2A.

When there is an input of the information indicating the start of betting, the control part 2e proceeds to the process of step S103. When there is no input of the information indicating the start of betting, the control part 2e ends the control process in the dealer terminal 2A.

### (Step S103)

In step S103, the control part 2e performs a process of setting (turning ON) the BET start flag to the BET start flag storage area for the table game A.

After performing the process of setting (turning ON) the BET start flag, the control part 2e proceeds to the process of step S104.

### (Step S104)

In step S104, the control part 2e performs a process of transmitting a BET start command 1 to the player terminals 4 via the transmission/reception part 2c and the first network 6.

It should be noted that, in the case of the dealer terminal 2B, a BET start command 2 is transmitted in step S104.

When the player terminal 4 receives the BET start command 1 (BET start command 2), a message such as “Bets allowed” is displayed in the BET information input image display area 405 and the BET information display portion 403 of the table game A selection image display portion 402A (table game B selection image display portion 402B) of the player terminal 4. Thus, the game player 12 can input the BET information with respect to the table game A (table game B) from the player terminal 4 by operating the input part 4a.

After transmitting the BET start command 1, the control part 2e proceeds to the process of step S105.

### (Step S105)

In step S105, the control part 2e determines whether or not a BET end announcement flag is set (turned ON) in the BET end announcement flag storage area for the table game A of the storage part 2d. The BET end announcement flag is set (turned ON) in the process of step S107, which is described later.

When the BET end announcement flag is set (turned ON) in the BET end announcement flag storage area for the table game A, the control part 2e proceeds to the process of step S109. When the BET end announcement flag is not set (turned ON) in the BET end announcement flag storage area for the table game A, the control part 2e proceeds to the process of step S106.

### (Step S106)

In step S106, the control part 2e determines whether or not the dealer 11 inputs information indicating the end of betting by operating the input part 2a of the dealer terminal 2A. Such an operation is performed at the timing when, for example, the dealer 11 observes the status of betting by the game players 12, and determines that the inputs of the BET information by the game players 12 are almost done.

When there is the input of the information indicating the end of betting, the control part 2e proceeds to the process of step S107. When there is no input of the information indicating the end of betting, the control part 2e ends the control process in the dealer terminal 2A.

### (Step S107)

In step S107, the control part 2e sets (turns ON) the BET end announcement flag to the BET end announcement flag storage area for the table game A, and starts counting by a timer (sets the timer), which is provided in the dealer terminal 2A.

The control part 2e proceeds to the process of step S108 after setting the BET end announcement flag and starting counting by the timer.

### (Step S108)

In step S108, the control part 2e performs a process of transmitting a BET end announcement command 1 to the player terminals 4.

It should be noted that, in the case of the dealer terminal 2B, a BET end announcement command 2 is transmitted in step S108.

When the player terminal 4 receives the BET end announcement command 1 (BET end announcement command 2), a message such as “oo seconds until bets are closed”, i.e., countdown by the counting by the timer, is displayed in the BET information input image display area 405 and the BET information display portion 403 of the table game A selection image display portion 402A (table game B selection image display portion 402B) of the player terminal 4.

The control part 2e proceeds to the process of step S109 after performing the process of transmitting the BET end announcement command 1.

### (Step S109)

In step S109, the control part 2e determines whether or not a BET end flag is set (turned ON) in the BET end flag storage area for the table game A. The BET end flag is set (turned ON) in the process of step S111 described later.

When the BET end flag is set, the control part 2e proceeds to the process of step S113. When the BET end flag is not set, the control part 2e proceeds to the process of step S110.

### (Step S110)

In step S110, the control part 2e determines whether or not the time counted by the timer, which is set in the process of step S107, reaches a predetermined time period (e.g., 10 seconds).

When it is determined that the predetermined time period has elapsed, the control part 2e proceeds'to the process of step S111. When it is not determined that the predetermined time period has elapsed, the control part 2e ends the control process in the dealer terminal 2A.

### (Step S111)

In step S111, the control part 2e performs a process of setting (turning ON) the BET end flag to the BET end flag storage area for the table game A.

The control part 2e proceeds to the process of step S112 after setting the BET end flag.

### (Step S112)

In step S112, the control part 2e performs a process of transmitting a BET end command 1 to the player terminals 4.

It should be noted that, in the case of the dealer terminal 2B, a BET end command 2 is transmitted in step S112.

When the player terminal 4 receives the BET end command 1 (BET end command 2), a message such as “Bets are closed” is displayed in the BET information input image display area 405 and the BET information display portion 403 of the table game A selection image display portion 402A (table game B selection image display portion 402B) of the player terminal 4. Thus, the game player 12 cannot input the BET information with respect to the currently performed table game A (table game B). After this process, the dealer 11 draws the cards C from the shoe 10, deals the cards C to Player and Banker, and opens the cards C, thereby determining the result of the game.

The control part 2e proceeds to the process of step S113 after transmitting the BET end command 1.

### (Step S113)

In step S113, the control part 2e determines whether or not the game result information is input by the dealer 11 by operating the input part 2a of the dealer terminal 2A. The game result information includes, for example, the card values of Banker, Player and the like, and the game result, e.g., Player win, Banker win, and Tie.

When the game result information is input, the control part 2e proceeds to the process of step S114. When the game result information is not input, the control part 2e ends the control process in the dealer terminal 2A.

### (Step S114)

In step S114, the control part 2e performs a process of transmitting a game end command 1 and the game result information to the player terminals 4.

It should be noted that, in the case of the dealer terminal 2B, a game end command 2 is transmitted in step S114.

The control part 2e proceeds to the process of step S115 after transmitting the game end command 1 and the game result information.

### (Step S115)

In step S115, the control part 2e performs a process of turning OFF the BET start flag, the BET end announcement flag, and the BET end flag that are set to the BET start flag storage area for the table game A, the BET end announcement flag storage area for the table game A, and the BET end flag storage area for the table game A, respectively.

The control part 2e ends the control process in the dealer terminal 2A after performing the process of turning OFF of each of these flags.

### (Player Terminal Control Process)

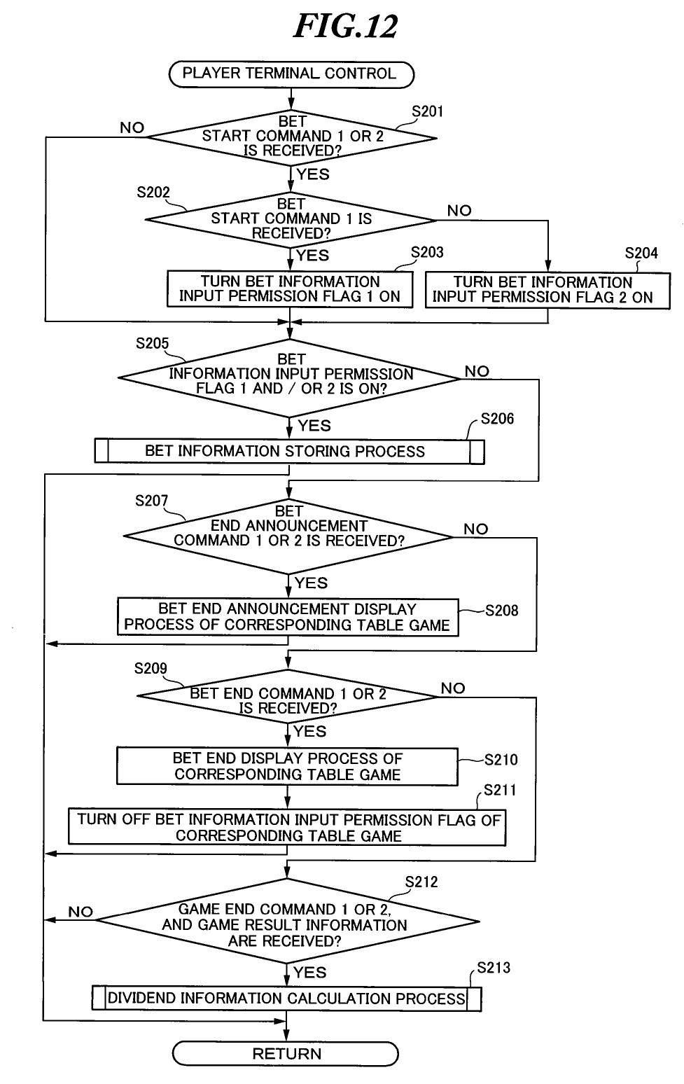

Next, referring to FIG. 12, a description is given of an exemplary control process in the player terminal 4.

### (Step S201)

In step S201, the control part 4h of the player terminal 4 determines whether or not the BET start command 1 (BET start command 2) is received from the dealer terminal 2A (dealer terminal 2B). The BET start command 1 (BET start command 2) is transmitted from the dealer terminal 2 in step S104 of the control process in the dealer terminal 2.

When the BET start command 1 or the BET start command 2 is received, the control part 4h proceeds to the process of step S202. When these commands are not received, the control part 4h proceeds to the process of step S205.

### (Step S202)

In step S202, the control part 4h determines whether or not the command received in the process of the above-described step S201 is the BET start command 1 transmitted from the dealer terminal 2A.

When the BET start command 1 is received, the control part 4h proceeds to the process of step S203. When the BET start command 1 is not received, i.e., when the BET start command 2 is received, the control part 4h proceeds to the process of step S204.

### (Step S203)

In step S203, the control part 4h performs a process of setting (turning ON) a BET information input permission flag 1 to the BET information input permission flag 1 storage area of the storage part 4f.

When the BET start command 1 is received, a message such as “Bets allowed” is displayed in the BET information display portion 403 of the table game A selection image display portion 402A. Additionally, when the game player 12 touches the display surface of the table game A selection image display portion 402A, in the case where the BET information input screen corresponding to the table game A is displayed in the BET information input image display area 405, a message such as “Bets allowed” is displayed at a predetermined position of the BET information input screen.

Further, the game player 12 can input the BET information with respect to the table game A on the condition that the BET information input permission flag 1 is set to the BET information input permission flag 1 storage area, and that the BET information input screen corresponding to the table game A is displayed in the BET information input image display area 405.

The control part 4h proceeds to the process of step S205 after setting the BET information input permission flag 1 to the BET information input permission flag 1 storage area.

### (Step S204)

In step S204, the control part 4h performs a process of setting (turning ON) the BET information input permission flag 2 to the BET information input permission flag 2 storage area of the storage part 4f.

When the BET start command 2 is received, a message such as “Bets allowed” is displayed in the BET information display portion 403 of the table game B selection image display portion 402B. Additionally, when the game player 12 touches the display surface of the table game B selection image display portion 402B, in the case where the BET information input screen corresponding to the table game B is displayed in the BET information input image display area 405, a message such as “Bets allowed” is displayed at a predetermined position of the BET information input screen.

Further, the game player 12 can input the BET information with respect to the table game B on the condition that the BET information input permission flag 2 is set to the BET information input permission flag 2 storage area, and that the BET information input screen corresponding to the table game B is displayed in the BET information input image display area 405.

The control part 4h proceeds to the process of step S205 after setting the BET information input permission flag 2 to the BET information input permission flag 2 storage area.

### (Step S205)

In step S205, the control part 4h determines whether or not at least one of the BET information input permission flag 1 and the BET information input permission flag 2 is set (turned ON).

The control part 4h proceeds to the process of step S206, when the BET information input permission flag 1 or the BET information input permission flag 2 is set to the corresponding one of the above-described storage areas. The control part 4h proceeds to the process of step S207, when the BET information input permission flag 1 or the BET information input permission flag 2 is not set (turned ON).

### (Step S206)

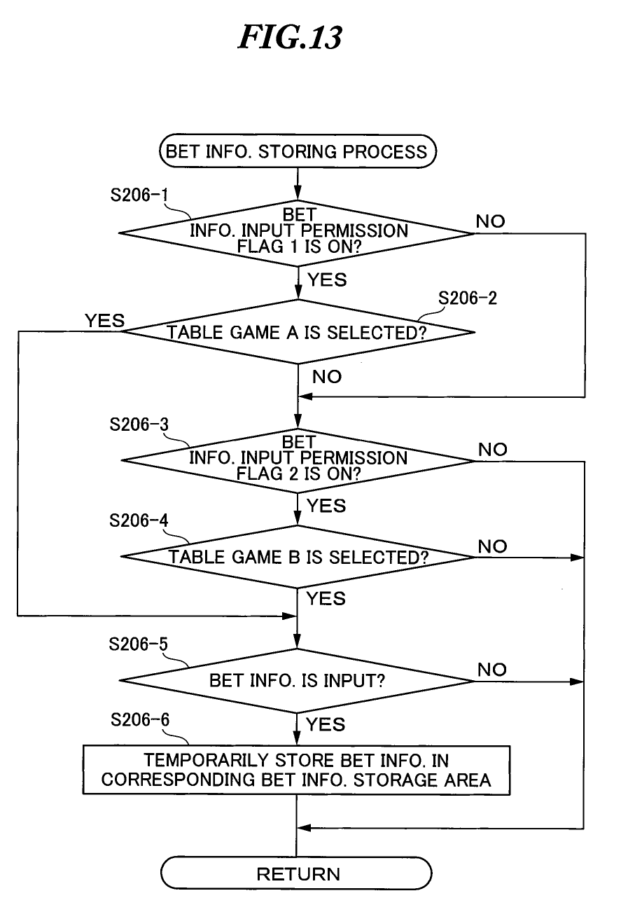

In step S206, the control part 4h performs a BET information storing process. The BET information storing process will be described later with reference to FIG. 13.

The control part 4h ends the control process in the player terminal 4 after performing the BET information storing process.

### (Step S207)

In step S207, the control part 4h determines whether or not the BET end announcement command 1 (BET end announcement command 2) is received from the dealer terminal 2A (dealer terminal 2B). The BET end announcement command 1 (BET end announcement command 2) is transmitted from the dealer terminal 2 in step S108 of the control process in the dealer terminal 2.

When the BET end announcement command 1 or the BET end announcement command 2 is received, the control part 4h proceeds to the process of step S208. When none of these commands are received, the control part 4h proceeds to the process of step S209.

### (Step S208)

When the BET end announcement command 1 is received, the control part 4h displays a message, such as “oo seconds until bets are closed”, in the BET information display portion 403 of the table game A selection image display portion 402A in step S208. Additionally, in the case where the BET information input screen corresponding to the table game A is displayed in the BET information input image display area 405, a message such as “oo seconds until bets are closed” is displayed at a predetermined position of the BET information input screen.

Similarly, when the BET end announcement command 2 is received, the control part 4h displays a message, such as “oo seconds until bets are closed”, in the BET information display portion 403 of the table game B selection image display portion 402B in step S208. Additionally, in the case where the BET information input screen corresponding to the table game B is displayed in the BET information input image display area 405, a message such as “oo seconds until bets are closed” is displayed at a predetermined position of the BET information input screen.

The control part 4h ends the control process in the player terminal 4 after performing the above-described BET end announcement display process.

### (Step S209)

In step S209, the control part 4h determines whether or not the BET end command 1 (BET end command 2) is received from the dealer terminal 2A (dealer terminal 2B). The BET end command 1 (BET end command 2) is transmitted from the dealer terminal 2 in step S112 of the control process in the dealer terminal 2.

When the BET end command 1 or the BET end command 2 is received, the control part 4h proceeds to the process of step S210. When these commands are not received, the control part 4h proceeds to the process of step S212.

### (Step S210)

When the BET end command 1 is received, the control part 4h displays a message such as “Bets are closed” in the BET information display portion 403 of the table game A selection image display portion 402A in step S210. Additionally, in the case where the BET information input screen corresponding to the table game A is displayed in the BET information input image display area 405, a message such as “Bets are closed” is displayed at a predetermined position of the BET information input screen.

Similarly, when the BET end announcement command 2 is received, the control part 4h displays a message, such as “Bets are closed”, in the BET information display portion 403 of the table game B selection image display portion 402B in step S210. Additionally, in the case where the BET information input screen corresponding to the table game B is displayed in the BET information input image display area 405, a message such as “Bets are closed” is displayed at a predetermined position of the BET information input screen.

The control part 4h proceeds to the process of step S211 after performing the above-described BET end display process.

### (Step S211)

When the BET end command 1 is received, the control part 4h performs, in step S211, a process of turning OFF the BET information input permission flag 1 that is set to the BET information input permission flag 1 storage area.

Similarly, when the BET end command 2 is received, the control part 4h performs, in step S211, a process of turning OFF the BET information input permission flag 2 that is set to the BET information input permission flag 2 storage area.

After performing the process of turning OFF the BET information input permission flag 1 (BET information input permission flag 2), the BET information cannot be input even when the BET information input screen corresponding to the table game A (table game B), which is displayed in the BET information input image display area 405, is touched.

The control part 4h ends the control process in the player terminal 4 after performing the process of turning OFF the BET information input permission flag 1 or the BET information input permission flag 2.

### (Step S212)

In step S212, the control part 4h determines whether or not the game end command 1 (game end command 2) and the game result information are received from the dealer terminal 2A (dealer terminal 2B). The game end command 1 (game end command 2) and the game result information are transmitted from the dealer terminal 2 in step S114 of the control process in the dealer terminal 2.

When the game end command 1 or the game end command 2, and the game result information are received, the control part 4h proceeds to the process of step S213. When these are not received, the control part 4h ends the control process in the player terminal 4.

### (Step S213)

In step S213, the control part 4h performs a dividend information calculation process. The dividend information calculation process will be described later with reference to FIG. 14.

The control part 4h ends the control process in the player terminal 4 after performing the dividend information calculation process.

### (Bet Information Storing Process)

Next, referring to FIG. 13, a description is given of an exemplary BET information storing process in the player terminal 4.

### (Step S206-1)

In step S206-1, the control part 4h determines whether or not the BET information input permission flag 1 is set to (turned ON in) the BET information input permission flag 1 storage area. The BET information input permission flag 1 is set in step S203 of the control process in the player terminal 4.

When the BET information input permission flag 1 is set to the BET information input permission flag 1 storage area, the control part 4h proceeds to the process of step S206-2. When the BET information input permission flag 1 is not set to the BET information input permission flag 1 storage area, the control part 4h proceeds to the process of step S206-3.

### (Step S206-2)

In step S206-2, the control part 4h determines whether or not the table game A is selected. Specifically, the control part 4h determines whether or not the BET information input screen corresponding to the table game A is displayed in the BET information input image display area 405, since the game player 12 touches the display surface of the table game A selection image display portion 402A.

When the table game A is selected, the control part 4h proceeds to the process of step S206-5. When the table game A is not selected, the control part 4h proceeds to the process of step 206-3.

### (Step S206-3)

In step S206-3, the control part 4h determines whether or not the BET information input permission flag 2 is set to (turned ON in) the BET information input permission flag 2 storage area. The BET information input permission flag 2 is set in step S204 of the control process in the player terminal 4.

When the BET information input permission flag 2 is set to the BET information input permission flag 2 storage area, the control part 4h proceeds to the process of step S206-4. When the BET information input permission flag 2 is not set to the BET information input permission flag 2 storage area, the control part control part 4h ends the BET information storing process.

### (Step S206-4)

In step S206-4, the control part 4h determines whether or not the table game B is selected. Specifically, the control part 4h determines whether or not the BET information input screen corresponding to the table game B is displayed in the BET information input image display area 405, since the game player 12 touches the display surface of the table game B selection image display portion 402B.

When the table game B is selected, the control part 4h proceeds to the process of step S206-5. When the table game B is not selected, the control part 4h ends the BET information storing process.

### (Step S206-5)

In step S206-5, the control part 4h determines whether or not the BET information (the predicted game result information and the betting amount information) is input by touching the display surface of the BET information input screen (the betting amount display portion 406, the mandatory predicted game result information display portion 407 or the optional predicted game result information display portion 408) displayed in the BET information input image display area 405.

Such an input of the BET information can be performed in the following manner. First, one of the betting amount information images 406a through 406d, which are displayed in the betting amount display portion 406 of the BET information input image display area 405, is touched via the display surface. Then, the game result information image displayed in the mandatory predicted game result information display portion 407 and/or the optional predicted game result information display portion 408 is touched via the display surface.

When the BET information is input, the control part 4h proceeds to the process of step S206-6. When the BET information is not input, the control part 4h ends the BET information storing process.

### (Step S206-6)

In step S206-6, the control part 4h performs a process of temporarily storing the BET information, which is input in the process of step S206-5, in the BET information storage area of the storage part 4f.

For example, when the betting amount information “$500” is bet to the predicted game result “Player”, and the betting amount information “$50” is bet to the predicted game result “Super 6” with respect to the table game A, as shown in FIG. 8, these kinds of information is written to the BET information storage area.

The control part 4h ends the BET information storing process after storing the BET information in the BET information storage area.

### (Dividend Information Calculation Process)

Next, referring to FIG. 14, a description is given of an exemplary dividend information calculation process in the player terminal 4.

### (Step S213-1)

In step S213-1, the control part 4h performs a process of temporarily storing, in the BET information storage area of the storage part 4f, the game result information received in the process of step S212.

For example, when the game result information in the table game B is “Banker (the card value ‘7’)”, as shown in FIG. 8, a process is performed which writes “Banker ‘7’” to the area of “game result information” of a record storing “B” (indicating the table game B) in the “table game information” in the BET information storage area.

The control part 4h proceeds to the process of step S213-2 after performing the process of temporarily storing the game result information.

### (Step S213-2)

In step S213-2, the control part 4h determines whether or not the predicted game result information (step S206-6) stored in the BET information storage area matches the game result information (step S213-1).

Taking FIG. 8 as an example, the control part 4h determines whether or not the predicated game result information “Banker” stored in the BET information storage area matches the game result information “Banker (the card value ‘7’)”. In this case, the control part 4h determines that these information match.

When the control part 4h determines that the predicated game result information matches the game result information, the control part 4h proceeds to the process of step S213-3. When the control part 4h determines that the predicted game result information does not match the game result information, the control part 4h ends the dividend information calculation process.

Additionally, on this occasion, when the predicated game result information matches the game result information, an indication that the prediction is correct is displayed at a predetermined position of the display part 4e. On the other hand, when the predicated game result information does not match the game result information, an indication that the prediction is incorrect is displayed at the predetermined position of the display part 4e.

### (Step S213-3)

In step S213-3, the control part 4h performs a process of transmitting, to the management server 5, a dividend rate information obtaining command, the game result information, and a player terminal ID which allows the identification of the player terminal 4.

The control part 4h proceeds to the process of step S213-4 after transmitting the above-described various data to the management server 5.

In this manner, according to this embodiment, the dividend rate information obtaining command, the game result information, and the player terminal ID are transmitted to the management server 5, only when the predicted game result information matches the game result information (step S213-2). Hence, it is possible to reduce the control load on the player terminal 4.

### (Step S213-4)

In step S213-4, the control part 4h determines whether or not the dividend rate information is received from the management server 5. The dividend rate information is transmitted to the player terminals 4 instep S304 of a control process in the management server 5, which will be described later.

When the dividend rate information is received, the control part 4h proceeds to the process of step S213-5. When the dividend rate information is not received, the control part control part 4h ends the dividend information calculation process.

### (Step S213-5)

In step S213-5, the control part 4h performs a process of temporarily storing, in the BET information storage area, the dividend rate information received in the process of step S213-4.

Taking FIG. 8 as an example, the control part 4h writes “×2” to the area of “dividend rate information” of a record in which the “predicted game result information” matches the “game result information” in the BET information storage area.

The control part 4h proceeds to the process of step S213-6 after storing the dividend rate information in the BET information storage area.

### (Step S213-6)

In step S213-6, the control part 4h performs a process of calculating the dividend information based on the dividend rate information and the betting amount information stored in the BET information storage area, and temporarily storing the calculated dividend information in the BET information storage area.

Taking FIG. 8 as an example, the control part 4h calculates “$100×2” based on the betting amount information “$100” and the dividend rate information “×2” stored in the BET information storage area, and obtains the dividend information “$200”. Then, a process is performed which writes the calculated dividend information “$200” to the “dividend information” area in the BET information storage area.

The control part 4h proceeds to the process of step S213-7 after calculating the dividend information.

### (Step S213-7)

In step S213-7, the control part 4h performs a process of displaying, on the display part 4e, the “dividend information” stored in the BET information storage area in the process of step S213-6.

Referring to FIG. 6, for example, when the dividend information “$250” is stored in the BET information storage area, “$250” is displayed in the money information display portion 413 (a dividend information display portion 413a) of the BET information input image display area 405. On this occasion, a total money information display portion 413b, which displays the total amount of money information possessed by the game player 12, of the money information display portion 413 displays the money information to which the dividend information is added.

The control part 4h proceeds to the process of step S213-8 after performing the process of displaying the dividend information on the display part 4e.

### (Step S213-8)

In step S213-8, the control part 4h performs a process of deleting the predicted game result information, the betting amount information, the game result information, the dividend rate information, and the dividend information which are temporarily stored in the BET information storage area.

The control part 4h ends the dividend information calculation process after performing the process of deleting the above-described various data.

### (Management Server Control)

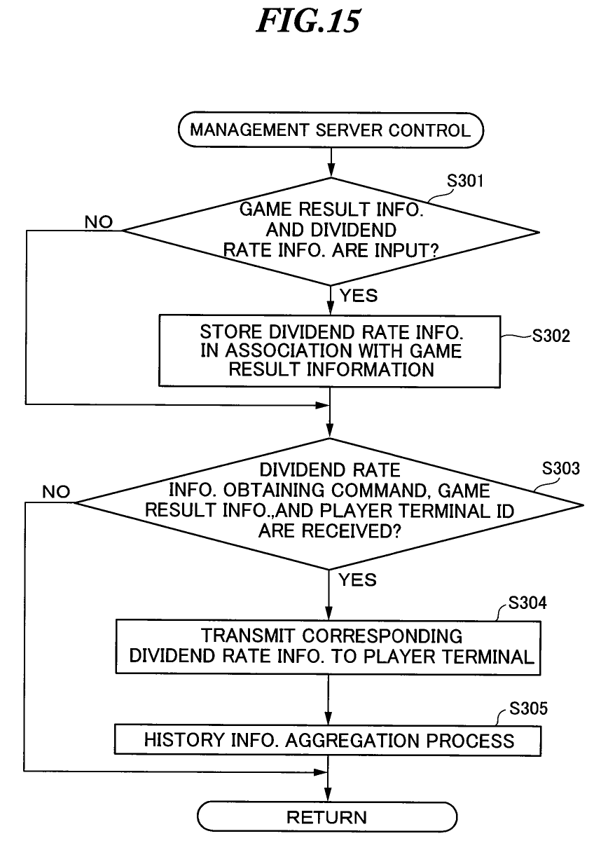

Next, referring to FIG. 15, a description is given of an exemplary control process in the management server 5.

### (Step S301)

In step S301, the control part 5e of the management server 5 determines whether or not the mandatory predicted game result information or the optional predicted game result information, and the corresponding dividend rate information are input by the employee or the like by operating the input part 5a.

Here, a description is given of an exemplary procedure for inputting, by the employee or the like, the above-described game result information and the corresponding dividend rate information.

First, the employee or the like operates the input part 5a, thereby causing the display part 5b to display a dividend rate information setting screen as shown in FIG. 10.

Next, the employee or the like inputs the above-described game result information and the corresponding dividend rate information, while viewing the dividend rate information setting screen. For example, as for the mandatory predicted game result information “Banker”, when the house desires to apply different kinds of dividend rate information for the case where the Banker wins with a specific card value (win on value of “6”), and the case where Banker wins with the other card values (all other wins), such information is input by operating the input part 5a.

Taking FIG. 10 as an example, as for “Banker”, the employee or the like inputs the dividend rate information (“×1.5”) for the case when Banker wins with the specific card value (win on value of “6”), and inputs the dividend rate information (“×2”) for the case when Banker wins with the other card values (all other wins). In this manner, it is possible to set two kinds of game result information with respect to the game result information “Banker”. When these kinds of information is stored in the dividend rate information storage area of the storage part 5c in the process of step S302 described later, the dividend information is calculated with these kinds of information reflected in the subsequent table games.

Additionally, for example, when the house desires to set “2 Draw” as the optional predicated game result information, and to set “×195” as the corresponding dividend rate information, such information is input by operating the input part 5a, in a manner similar to the above-described input of the mandatory predicted game result information and the corresponding dividend rate information.

It is possible to perform the setting of the game result information and the corresponding dividend rate information as described above for each of the game table A and the table game B.

When the mandatory predicted game result information or the optional predicted game result information and the corresponding dividend rate information are input, the control part 5e proceeds to the process of step S302. When these kinds of information is not input, the control part 5e proceeds to the process of step S303.

### (Step S302)

In step S302, the control part 5e performs a process of storing, in the dividend rate information storage area of the storage part 5c, the mandatory predicted game result information or the optional predicted game result information, and the corresponding dividend rate information that are input in the process of step S301.

The control part 5e proceeds to the process of step S303 after performing the process of storing the above-described various information in the dividend rate information storage area.

### (Step S303)

In step S303, the control part 5e determines whether or not the dividend rate information obtaining command, the game result information, and the player terminal ID are received from the player terminal 4. The dividend rate information obtaining command, the game result information, and the player terminal ID are transmitted to the management server 5 in step S213-3 of the dividend information calculation process in the player terminal 4.

When the above-described various data are received, the control part 5e proceeds to the process of step S304. When the various data are not received, the control part 5e ends the control process in the management server 5.

### (Step S304)

In step S304, the control part 5e performs a process of searching the dividend rate information storage area of the storage part 5c for the dividend rate information corresponding to the game result information received in the process of step S303, and transmitting the searched dividend rate information to the player terminal 4 corresponding to the player terminal ID received in the process of step S303.

The control part 5e proceeds to the process of step S305 after performing the process of searching for the dividend rate information, and transmitting the dividend rate information to the player terminal 4.

As described above, in this embodiment, the game result information and the corresponding dividend rate information are stored in the management server 5 instead of the player terminal 4. Hence, it is possible to eliminate a cumbersome process, such as storing, in each of the player terminals 4, the game result information and the corresponding dividend rate information every time these kinds of information is changed.

Moreover, since the dividend rate information is not stored in the player terminals 4, it is possible to positively prevent a fraud, such as changing the dividend rate information in order to obtain a large benefit.

Further, according to this embodiment, the dividend rate information is transmitted to only the player terminals 4 that request transmission of the dividend rate information. Hence, it is possible to reduce the control load on the management server 5.

### (Step S305)

In step S305, the control part 5e performs a process of storing, in the history information storage area of the storage part 5c, the game result information received in the process of step S303. Thus, it is possible to aggregate the game result information including a series of recent card value data. Hence, it is also possible to create the baccarat result table based on the aggregated game result information. In this case, by transmitting such information to the player terminal 4, it is possible to display the baccarat result table in the history information display portion 404 of the player terminal 4.

The control part 5e ends the control process in the management server 5 after performing the process of storing the game result information in the history information storage area.

Additionally, in this embodiment, the dividend rate information obtaining command, the game result information, and the player terminal ID are received (step S213-3, step S303) from the player terminal 4 whose predicted game result information matches the game result information (step S213-2). However, this is not the limitation, and it is also possible to apply a configuration in which the betting amount information as well as the above-described various data are received from all of the player terminals 4. With such a configuration, it is possible for the management server 5 to calculate the dividend information for all of the player terminals 4, and to store this information as the history. In such a case, by referring to the history, the house can keep track of the sale of the house and the like.

As described above, according to this embodiment, the various data transmitted among the dealer terminals 2, the player terminals 4, and the management server 5, and the image data transmitted between the capturing cameras 3 and the player terminals 4 are separately transmitted via the first network 6 and the second network 7, respectively. Hence, it is possible to reduce the loads on these networks, and to smoothly transmit the image data as well as the various data. Accordingly, it is possible to transmit the various data without a delay, and thus it is possible to smoothly progress the table game. Further, since the game player 12 can see the card images on a real-time basis, it is possible to effectively prevent a fraud by the dealer 11.

Additionally, in this embodiment, only the image data not always necessary for proceeding with the table game is transmitted via the second network 7, which is different from the first network 6. Accordingly, even when a trouble occurs in the second network 7 such as breaking or disconnection, the first network 6 is not affected by the trouble. Therefore, it is possible to effectively prevent a disadvantage that the progress of the table games is stopped due to such a trouble.

According to this embodiment, it is possible to additionally set the optional predicted game result information, such as “2 Draw”, which is arbitrarily determined by the house, in addition to the mandatory predicted game result information, such as “Banker” and the like, which are necessary in a baccarat game. In addition, it is possible to arbitrarily set the dividend rate information corresponding to these kinds of game result information. Namely, it is possible to arbitrarily increase the game result information of a baccarat game as a table game. Hence, it is possible to add new fun to the table game as a baccarat game, and to positively improve the enjoyment of the table game. Further, since the house can change the dividend rate information in consideration of the sale and the like, it is possible for the house to expect an increase in the benefit.

In addition, the game result information and the corresponding dividend rate information are stored in the management server 5 instead of each of the player terminals 4. Hence, when these kinds of information is changed, it is possible to eliminate a cumbersome process for storing the changed information in each of the player terminals 4. Moreover, since the dividend rate information is not stored in the player terminals 4, it is possible to positively prevent a fraud, such as changing the dividend rate information in order to obtain a large benefit.

Additionally, according to this embodiment, the dividend rate information is transmitted to only the player terminals 4 that request transmission of the dividend rate information. Hence, it is possible to reduce the control load on the management server 5.

In this embodiment, by selecting and touching the display surface of one of the table game A selection image display portion 402A and the table game B selection image display portion 402B, it is possible to display the screen which allows the input of the BET information with respect to the table game A or the screen which allows the input of the BET information with respect to the table game B. Hence, it is possible for the game player 12 to view how much bets are placed and the status or the like of another table game as well as the currently selected table game. Accordingly, the game player 12 can see these kinds of information at the same time without performing any specific operation.

Additionally, when one of the table game A selection image display portion 402A and the table game B selection image display portion 402B is selected by touching the display surface of the selected one of the display portions, the contents of the BET information display portion 403 and the like displayed in the unselected display portion are displayed somewhat darkly, so that the contents become less visible, though the contents can be viewed by the game player 12. Hence, it is possible to immediately recognize the currently selected table game. Accordingly, it is possible to prevent the game player 12 from placing a bet on a different table game.

In addition, according to this embodiment, when one of the betting amount information images (406a through 406d), imitating the chips, is touched via the display surface of the input part 4a, the selected (touched) image is moved upward. That is, the game player 12 can clearly recognize the betting amount information (the betting amount for a single operation that is currently set). Hence, it is possible to prevent a disadvantage that an erroneous betting amount is bet to the predicted game result.

### Second Embodiment

Further, in the first embodiment, the calculation of the dividend information is performed in the player terminal 4. However, the calculation of the dividend information can also be performed in the management server 5.

In this case, the calculation of the dividend information can be performed in the management server 5 by modifying the above-described operation of the table game system (FIG. 11 through FIG. 15) in the following manner.

In the control process in the dealer terminal 2 (see FIG. 11), the process of transmitting the game end command and the game result information to “the player terminal 4” instep S114 is modified to a process of transmitting the game end command and the game result information to “the management server 5” (step S114′).

Next, in the control process in the player terminal 4 (see FIG. 12), the process of “determining whether or not the game end command 1 (game end command 2) and the game result information are received from the dealer terminal 2A (dealer terminal 2B)” in step S212 is modified to a process of “determining whether or not the dividend information is received from the management server 5” (step S212′).

Additionally, in the control process in the player terminal 4 (see FIG. 12), the “dividend information calculation process” in step S213 is modified to a process of “displaying the dividend information on the display part 4d” (step S213′).

In addition, in the BET information storing process in the player terminal 4 (see FIG. 13), the process of “temporarily storing, in the BET information storage area of the storage part 4f, the BET information that is input in the process of step S206-5” in step S206-6 is modified to a process of “transmitting, to the management server 5, the BET information that is input in the process of step S206-5, and the table game information indicating the type of the table game A or the table game B, and the player terminal ID” (step S206-6′).

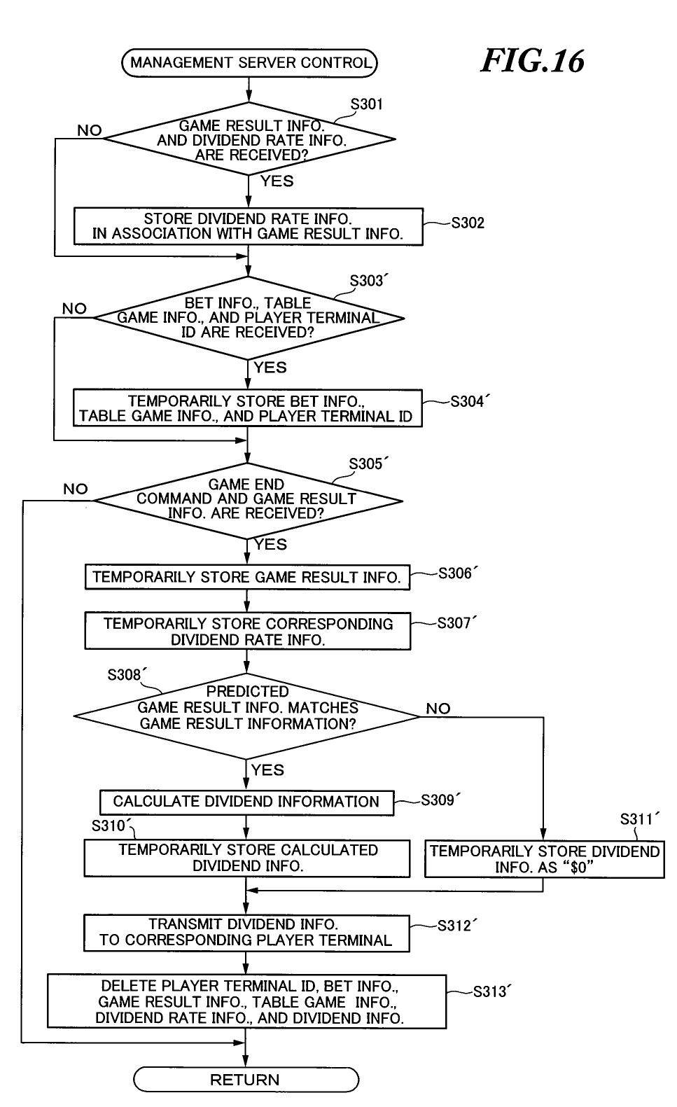

Further, the control process in the management server 5 shown in FIG. 15 is modified to an exemplary control process in the management server 5 according to the second embodiment shown in FIG. 16.

### (Management Server Control)

Hereinafter, referring to FIG. 16, a description is given of an exemplary control process in the management server 5 according to the second embodiment. It should be noted that the processes of steps S301 and S302 in FIG. 16 are the same as those in the control process in the management server 5 shown in FIG. 15, and thus a description thereof will be omitted.

### (Step S303′)

In step S303′, the control part 5e of the management server 5 determines whether or not the BET information (the betting amount information and the predicted game result information), the table game information indicating the type of the table game A or the table game B, and the player terminal ID are received from the player terminal 4. The BET information, the table game information, and the player terminal ID are transmitted from the player terminal 4 in step S206-6′ of the BET information storing process in the player terminal 4.

When the BET information, the table game information, and the player terminal ID are received from the player terminal 4, the control part 5e proceeds to the process of step S304′. When the BET information, the table game information, and the player terminal ID are not received, the control part 5e proceeds to the process of step S305′.

### (Step S304′)

In step S304′, the control part 5e performs a process of temporarily storing, in the storage part 5c, the player terminal ID, the BET information (the betting amount information and the predicted game result information), and the table game information.

The storage part 5c according to the second embodiment includes a dividend information storage area, in addition to the dividend rate information storage area and the history information storage area described above.

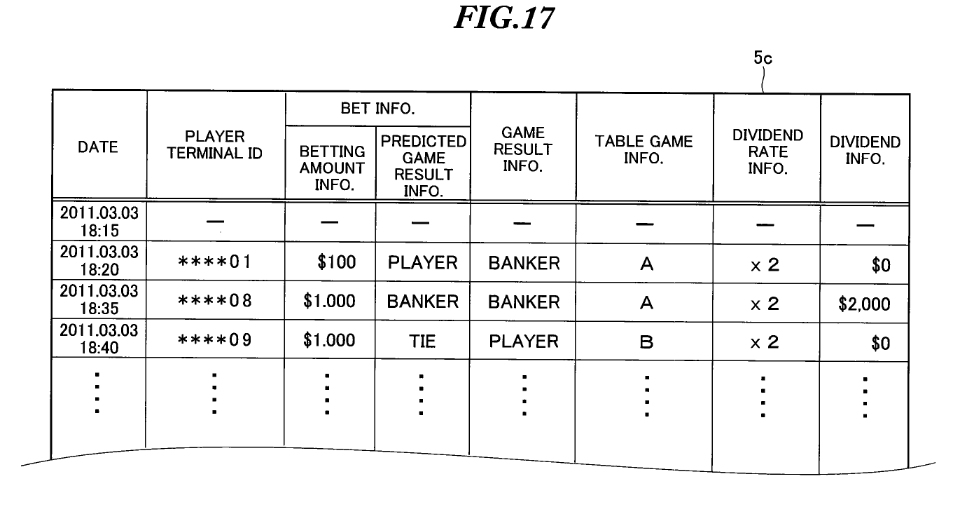

As shown in FIG. 17, when the control part 5e receives, for example, the player terminal ID “****08”, the betting amount information “$1,000”, the predicated game result information “Banker”, and the table game information “A”, the control part 5e writes these kinds of information to the dividend information storage area.

The control part 5e proceeds to the process of step S305′ after performing the process of storing, in the dividend information storage area, the player terminal ID, the BET information, and the table game information.

### (Step S305′)

In step S305′, the control part 5e determines whether or not the game end command and the game result information are received from the dealer terminal 2. The game end command and the game result information are transmitted to the management server 5 in step S114′ of the control process in the dealer terminal 2.

When the game end command and the game result information are received, the control part 5e proceeds to the process of step S306′. When these kinds of information is not received, the control part 5e ends the control process in the management server 5.

### (Step S306′)

In step S306′, the control part 5e performs a process of temporarily storing, in the dividend information storage area, the game result information received in the process of step S305′.

For example, when the game result information “Banker (the card value ‘7’)” is received from the dealer terminal 2A, first, the control part 5e searches for a record having “A” stored in the “table game information” area of the dividend information storage area shown in FIG. 17. Next, when the control part 5e determines that such a record exists, the control part 5e writes “Banker” to the “game result information” area of the record.

The control part 5e proceeds to the process of step S307′ after performing the process of temporarily storing the game result information in the dividend information storage area.

### (Step S307′)

In step S307′, the control part 5e performs a process of obtaining, from the dividend rate information storage area, the dividend rate information corresponding to the game result information received in the process of step S305′, and temporarily storing the obtained dividend rate information in the dividend information storage area.

For example, when the game result information received from the dealer terminal 2A is “Banker (the card value ‘7’)”, first, the control part 5e obtains the dividend rate information “×2” from the dividend rate information storage area. Next, the control part 5e searches for a record having “Banker (the card value ‘7’)” stored in the “game result information” area of the dividend information storage area shown in FIG. 17, and writes “×2” to the “dividend rate information” area of the record.

The control part 5e proceeds to the process of step S308′ after performing the process of temporarily storing the dividend rate information in the dividend information storage area.

### (Step S308′)

In step S308′, the control part 5e performs a process of determining whether or not the predicted game result information stored in the process of step S304′ matches the game result information stored in the process of step S306′.

When the predicted game result information matches the game result information, the control part 5e proceeds to the process of step S309′. When the predicted game result information does not match the game result information, the control part 5e proceeds to the process of step S311′.

### (Step S309′)

In step S309′, the control part 5e performs a process of calculating the dividend information, based on the betting amount information stored in the process of step S304′ and the dividend rate information stored in the process of step S307′.

As shown in FIG. 17, for example, when the betting amount information “$1,000” and the dividend rate information “×2” are stored in the dividend information storage area, the control part 5e performs a calculation “$1,000×2=$2,000”.

The control part 5e proceeds to the process of step S310′ after performing the calculation of the dividend information.

### (Step S310′)

In step S310′, the control part 5e performs a process of writing (temporarily storing) the dividend information calculated in the process of step S309′ to the “dividend information” area of the dividend information storage area.

The control part 5e proceeds to the process of step S312′ after performing the process of writing (temporarily storing) the dividend information in the dividend information storage area.

### (Step S311′)

In step S311′, the control part 5e performs a process of writing (temporarily storing) “$0” to the “dividend information” area of the dividend information storage area (see FIG. 17).

The control part 5e proceeds to the process of step S312′ after performing the process of temporarily storing “$0” in the dividend information storage area.

### (Step S312′)

In step S312′, the control part 5e performs a process of transmitting, to the player terminal 4 corresponding to the player terminal ID, the dividend information stored in the “dividend information” of the dividend information storage area.

The control part 5e proceeds to the process of step S313′ after performing the process of transmitting the dividend information to the player terminal 4.

### (Step S313′)

In step S313′, the control part 5e performs a process of deleting, from the dividend information storage area, the BET information, the table game information, and the player terminal ID stored in the process of step S304′, and the game result information stored in the process of step S306′, the dividend rate information stored in the process of step S307′, and the dividend information stored in the process of step S310′ and step S311′.

The control part 5e ends the control process in the management server 5 after performing the process of deleting the various data from the dividend information storage area.

As described above, according to the second embodiment, the calculation of the dividend information is performed in the management server 5 instead of the player terminal 4. Hence, it is possible to positively reduce the control load on the player terminal 4.

The description has been given above of the embodiments to which the present invention made by the inventors is applied. However, the present invention is not limited to the embodiments described in this specification and/or illustrated in the drawings. It is to be appreciated by those skilled in the art that various modifications may be made without departing from the spirit and scope of the appended claims.

A description is given below of the corresponding relationship between the above-described embodiments and the appended claims.

“The dealer's game table 1” according to the above-described embodiments corresponds to “a dealer's game table” recited in the claims.

“The dealer terminal 2” according to the above-described embodiments corresponds to “a dealer terminal” recited in the claims.

“The capturing camera 3” according to the above-described embodiments corresponds to “a capturing device” recited in the claims.

“The player terminal 4” according to the above-described embodiments corresponds to “a player terminal” recited in the claims.

“The display part 4e” according to the above-described embodiments corresponds to “a player display part” recited in the claims.

“The management server 5” according to the above-described embodiments corresponds to “a management server” recited in the claims.

“The first network 6” according to the above-described embodiments corresponds to “a first communication line” recited in the claims.

“The second network 7” according to the above-described embodiments corresponds to “a second communication line” recited in the claims.

According to the present invention, it is possible to smoothly proceed with a table game, and to effectively prevent a fraud by a dealer. Hence, it is possible to apply the present invention to various table game systems using game media such as cards.

1. A table game system, comprising:
a dealer's game table for performing a table game;
a dealer terminal configured to allow input of game result information of the table game performed on the dealer's game table;
a capturing device configured to be able to capture game medium used in the table game;
a player display part configured to be able to display an image of the game medium captured by the capturing device, the player display part being provided at a location distant from the dealer's game table;
a player terminal configured to allow input of bet information including predicted game result information and betting amount information, the player terminal being provided at a location distant from the dealer's game table;
a management server configured to store predetermined dividend rate information corresponding to the game result information;
a first communication line configured to connect the dealer terminal, the player terminal, and the management server to each other; and
a second communication line configured to connect the capturing device to the player display part, the second communication line being different from the first communication line.

2. The table game system according to claim 1,
wherein the dealer terminal transmits the game result information to the player terminal,
the management server transmits the dividend rate information to the player terminal, and
the player terminal stores the bet information that is input, and the game result information and the dividend rate information that are received,
determines whether or not the predicted game result information matches the game result information, and,
when the player terminal determines that the predicted game result information matches the game result information, calculates dividend information based on the betting amount information and the dividend rate information.

3. The table game system according to claim 1,
wherein the dealer terminal transmits the game result information to the management server,
the player terminal transmits the bet information to the management server, and
the management server stores the game result information and the bet information that are received,
determines whether or not the predicted game result information matches the game result information, and
when the management server determines that the predicted game result information matches the game result information, calculates dividend information based on the betting amount information and the dividend rate information, and the player terminal receives the dividend information.
